(19) United States
(12) Patent Application Publication
(10) Pub. No.: US 2016/0250786 A1
(43) Pub. Date: Sep. 1, 2016

(54) METHOD FOR PRODUCING VEHICLE SEAT PAD

(71) Applicants: TOYOTA BOSHOKU CORPORATION, Aichi (JP); SANYO CHEMICAL INDUSTRIES, LTD., Kyoto (JP)

(72) Inventors: Yoshiyuki Murata, Kariya-shi (JP); Tetsuo Hayashida, Kariya-shi (JP); Shota Matsushita, Kariya-shi (JP); Katsuya Uchida, Kyoto-shi (JP); Tsuyoshi Tsukamoto, Kyoto-shi (JP)

(73) Assignees: TOYOTA BOSHOKU CORPORATION, Kariya-shi, Aichi (JP); SANYO CHEMICAL INDUSTRIES, LTD., Kyoto-shi, Kyoto (JP)

(21) Appl. No.: 15/032,865

(22) PCT Filed: Oct. 28, 2014
(86) PCT No.: PCT/JP2014/005439

§ 371 Date: Apr. 28, 2016

(30) Foreign Application Priority Data
Oct. 29, 2013 (JP) 2013-224081

(51) Int. Cl. B29C 44/34; C08G 18/48; B29C 44/14; C08G 18/08

(52) U.S. Cl. CPC B29C 44/355; C08G 18/14; C08G 18/4841; B29C 44/14; C08G 2101/0008

(57) ABSTRACT

The objective of the present invention is to provide a method for producing a vehicle seat pad, in which it is difficult for aldehydes to be dispersed, in a favorably curable manner. The method for producing a vehicle seat pad and containing a step (I) for obtaining a flexible polyurethane foam by reacting an active hydrogen component (A) and an organic polyisocyanate (B) in the presence of a foaming agent (C), a urethanation agent (D), a foam stabilizer (E), and an additive (F), wherein (C) contains water, (F) contains at least one selected from the group consisting of the urea compound (F1) indicated by general formula (1), an amino acid (F2), and a polyvalent phenol (F3), and the flexible polyurethane foam has a core density of 25-90 kg/m³, a resilience of 50-75%, and a hardness (25%-ILD) of 150-400 N/cm².

### TECHNICAL FIELD

The present invention relates to a method for producing a vehicle seat pad.

### BACKGROUND ART

In recent years, since aldehydes (a volatile organic compound (VOC)) such as formaldehyde causes a sick house syndrome and the like, it is desired not to diffuse these compounds as much as possible in housing-related fields. Such circumstances hold true for the inside of a vehicle cabin of an automobile or the like, and measures against VOC have been required.

For example, soft urethane foam with high cushioning properties is used for a vehicle seat pad, and formaldehyde, acetaldehyde and the like, which are contained in the raw material for polyurethane foam or generated at the time of a urethanation reaction, are diffused from the pad after molding of these kinds of urethane foam, and therefore it is desired to reduce the generation of these kinds of aldehydes.

For the purpose of preventing the volatilization of aldehydes, a method of applying an aldehyde scavenger on the surface of a seat pad (Patent Document 1) has hitherto been known.

Moreover, a method of mixing a polyol compound with a hydrazine compound having an action of decomposing aldehydes (Patent Document 2) has been known.

### PRIOR ART DOCUMENT

### Patent Documents

Patent Document 1: JP-A-2005-124743
Patent Document 2: JP-A-2006-182825

### SUMMARY OF THE INVENTION

### Problems to be Solved by the Invention

However, even when the method of Patent Document 1 is adopted, the method is poor in workability since it is necessary to apply an aldehyde scavenger to a seat pad after foam molding, and moreover, even when the method of Patent Document 2 is adopted, it is necessary to heat a seat pad for a long period of time on production of the seat pad since the seat pad is poor in curing properties and there is a problem that the method is low in productivity.

The present invention is aimed at providing a method for producing a vehicle seat pad, from which aldehydes are hardly diffused, in a favorably curable manner.

### Solutions to the Problems

The present inventors have conducted studies in view of achieving the object mentioned above, and as a result, have completed the present invention.

That is, the present invention is directed to a method for producing a vehicle seat pad, including Step (I) of obtaining flexible polyurethane foam by allowing an active hydrogen component (A) and an organic polyisocyanate (B) to undergo a reaction in the presence of a foaming agent (C), a urethanation catalyst (D), a foam stabilizer (E) and an additive (F), wherein the (C) contains water, the (F) contains at least one kind selected from the group consisting of a urea compound (F1) represented by general formula (1) below, an amino acid (F2) and a polyhydric phenol (F3), the flexible polyurethane foam has a core density of 25 to 90 kg/m³, a resilience of 50 to 75% and a hardness (25%-ILD) of 150 to 400 N/cm².

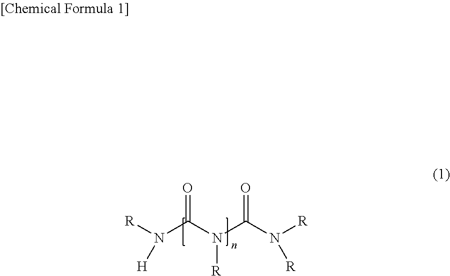

[In general formula (1), R represents a hydrogen atom, an alkyl group with 1 to 4 carbon atoms or a hydroxyl group, Rs may be the same as or different from one another, but at least one of Rs represents a hydrogen atom. n represents an integer of 0 to 3.]

### Effects of the Invention

By the method for producing a vehicle seat pad according to the present invention, it is possible to produce a vehicle seat pad having little diffusion of aldehydes. Moreover, the seat pad is also satisfactory in curing properties on production.

### MODE FOR CARRYING OUT THE INVENTION

From the viewpoints of moldability and mechanical properties, it is preferred that the active hydrogen component (A) used in the present invention contain a polyether polyol (A0) with a number average functional group number of 2 to 8, a hydroxyl value of 14 to 54 (mgKOH/g) and an oxyethylene unit content of 5 to 30% by weight.

The number average functional group number of the (A0) is 2 to 8, and from the viewpoints of moldability and mechanical properties, it is preferably 2 to 6, and further preferably 2 to 5.

In this connection, in the present invention, the functional group number of the polyether polyol [(A0) and (A1) described below] is considered to be equal to the functional group number of an active hydrogen-containing compound which is a starting material.

The hydroxyl value of the (A0) is 14 to 54 (mgKOH/g), and from the viewpoints of curing properties and mechanical properties, it is preferably 17 to 50 (mgKOH/g), and further preferably 20 to 45 (mgKOH/g).

The hydroxyl value in the present invention is measured by a method prescribed in JIS K1557-1.

The oxyethylene unit content of the (A0) is 5 to 30% by weight, and from the viewpoints of moldability and mechanical properties, it is preferably 5 to 25% by weight, and further preferably 5 to 20% by weight.

Examples of the (A0) include a compound with a structure in which an alkylene oxide (hereinafter, abbreviated as AO) is added to a compound containing at least two (preferably two to eight) active hydrogen atoms (a polyhydric alcohol, a polyhydric phenol, an amine, a polycarboxylic acid and phosphoric acid, or the like), and the like.

As the polyhydric alcohol, a dihydric alcohol with 2 to 20 carbon atoms, a trihydric alcohol with 3 to 20 carbon atoms, and a polyhydric alcohol as a tetra- to octahydric alcohol with 5 to 20 carbon atoms are included.

As the dihydric alcohol with 2 to 20 carbon atoms, a linear or branched aliphatic diol, an alicyclic diol, and the like are included. As the linear or branched aliphatic diol, an alkylene glycol and the like are included, and specifically, examples thereof include ethylene glycol, 1,2- and 1,3-propylene glycols, 1,3- and 1,4-butanediols, 1,6-hexanediol, neopentyl glycol, and the like. As the alicyclic diol, a cycloalkylene glycol and the like are included, and specifically, examples thereof include cyclohexanediol, cyclohexanedimethanol, and the like.

As the trihydric alcohol with 3 to 20 carbon atoms, an aliphatic triol and the like are included. As the aliphatic triol, an alkanetriol and the like are included, and specifically, examples thereof include glycerol, trimethylol propane, trimethylol ethane, hexanetriol, and the like.

As the polyhydric alcohol as a tetra- to octahydric alcohol with 5 to 20 carbon atoms, an aliphatic polyol and saccharides are included. As the aliphatic polyol, an alkanepolyol and the like are included, and specifically, examples thereof include pentaerythritol, sorbitol, mannitol, sorbitan, diglycerol, dipentaerythritol, and the like. Moreover, as the aliphatic polyol, an intramolecular dehydration product of an alkanetriol and an alkanepolyol, and an intermolecular dehydration product of an alkanetriol and/or an alkanepolyol are also included. Specifically, examples of saccharides include sucrose, glucose, mannose, fructose, methyl glucoside and the like, and a derivative thereof is also included.

As the polyhydric (di- to octahydric) phenol, a monocyclic polyhydric phenol, a bisphenol, a condensate (novolak) of phenol and formaldehyde, a polyphenol, combined use of two or more kinds thereof, and the like are included. Examples of the monocyclic polyhydric phenol include pyrogallol, hydroquinone, phloroglucin, and the like. Examples of the bisphenol include bisphenol A, bisphenol F, bisphenol sulfone, and the like. Examples of the polyphenol include those described in U.S. Pat. No. 3,265,641, and the like.

As the amine, those with two to eight active hydrogen atoms are included, and ammonia, a linear or branched aliphatic amine, an aromatic amine, an alicyclic amine and a heterocyclic amine are included.

Examples of the linear or branched aliphatic amine include alkanolamines with 2 to 20 carbon atoms (monoethanolamine, diethanolamine, triethanolamine, isopropanolamine, aminoethyl ethanolamine, and the like), alkylamines with 1 to 20 carbon atoms (n-butylamine, octylamine, and the like), alkylenediamines with 2 to 6 carbon atoms (ethylenediamine, propylenediamine, hexamethylenediamine, and the like) and polyalkylenepolyamines with 4 to 20 carbon atoms (those with 2 to 6 carbon atoms of the alkylene group, and the like, specifically, diethylenetriamine, triethylenetetramine, and the like).

Examples of the aromatic amine include aromatic mono- or polyamines with 6 to 20 carbon atoms (aniline, phenylenediamine, tolylenediamine, xylylenediamine, diethyltoluenediamine, methylenedianiline, diphenyl ether diamine, and the like), and the like.

Examples of the alicyclic amine include alicyclic amines with 4 to 20 carbon atoms (isophoronediamine, cyclohexylenediamine, dicyclohexylmethanediamine, and the like), and the like.

Examples of the heterocyclic amine include heterocyclic amines with 4 to 20 carbon atoms (piperazine, aminoethyl piperazine, those described in JP 55-21044 B, and the like), and the like.

Examples of the polycarboxylic acid include aliphatic polycarboxylic acids with 4 to 18 carbon atoms (succinic acid, adipic acid, sebacic acid, glutaric acid, azelaic acid, and the like), aromatic polycarboxylic acids with 8 to 18 carbon atoms (phthalic acid, terephthalic acid, isophthalic acid, trimellitic acid, and the like), and the like.

Two or more kinds of these active hydrogen-containing compounds may be combinedly used. Of these, from the viewpoints of curing properties and mechanical properties, a polyhydric alcohol is preferred.

As the AO to be added to an active hydrogen-containing compound, an AO composed of a 1,2-AO with 3 or more carbon atoms and ethylene oxide (hereinafter, abbreviated as EO) is preferred, examples of the 1,2-AO with 3 or more carbon atoms include 1,2-propylene oxide (hereinafter, abbreviated as PO), 1,2-butylene oxide, styrene oxide, and the like, and of these, PO is preferred from the viewpoint of productivity of the active hydrogen component (A).

It is preferred that the AO be composed only of a 1,2-AO with 3 or more carbon atoms and EO, but the AO may be an adduct in which another AO in an amount in the range of 10% by weight or less (further preferably 5% by weight or less) in the AO is combinedly used. As the other AO, an AO with 4 to 8 carbon atoms is preferred, examples thereof include 1,3-, 1,4- and 2,3-butylene oxides, and the like, and two or more kinds thereof may be used.

As the AO addition method, either of block addition and random addition is acceptable, but it is preferred that at least an active hydrogen group at the terminal of a polyol be formed by block addition.

As a catalyst used in the AO addition, catalysts described in JP-A-2000-344881 [tris(pentafluorophenyl)borane and the like] and catalysts described in JP-A-11-120300 (magnesium perchlorate and the like) may be used (the same holds true for the AO adduct below) in addition to alkali catalysts (KOH, CsOH and the like).

From the viewpoints of curing properties and mechanical properties, the content of the (A0) is preferably 8 to 98% by weight, further preferably 10 to 97% by weight, especially preferably 12 to 95% by weight and most preferably 20 to 90% by weight, based on the weight of the active hydrogen component (A).

In the present invention, another active hydrogen component other than the polyether polyol (A0) may be contained in the active hydrogen component (A), and examples thereof include a polyether polyol (A1) other than the (A0), a polyester polyol (A2), a polyhydric alcohol (A3), polyols other than those mentioned above and a monool (A4), and a polymer polyol (A5) obtained by allowing a vinyl monomer to undergo a polymerization in these polyols, an amine (A6), a mixture thereof, and the like.

Examples of the polyether polyol (A1) other than the (A0) include those that are compounds with a structure in which an AO is added to a compound containing at least two active hydrogen atoms (a polyhydric alcohol, a polyhydric phenol, an amine, a polycarboxylic acid and phosphoric acid, or the like) and do not correspond to the (A0), and the polyether polyol may be used alone or two or more kinds thereof may be combinedly used.

Examples of the compound containing active hydrogen include ones that are the same as those used for the polyether polyol (A0).

Of these, from the viewpoint of moldability, a polyhydric alcohol is preferred, and from the viewpoints of curing properties and mechanical properties, further preferred are an aliphatic polyhydric alcohol and an alicyclic polyhydric alcohol, and especially preferred is an aliphatic polyhydric alcohol.

As the AO to be added to a compound containing active hydrogen, from the viewpoint of moldability, an AO with 2 to 8 carbon atoms is preferred, and examples thereof include EO, PO, 1,2-, 1,3-, 1,4- and 2,3-butylene oxides, styrene oxide, and combined use of two or more kinds thereof (block and/or random addition) and the like. Of these, from the viewpoint of curing properties, PO and combined use of PO and EO are preferred, and further preferred is combined use of PO and EO.

As a catalyst used in the AO addition, catalysts described in JP-A-2000-344881 [tris(pentafluorophenyl)borane and the like] and catalysts described in JP-A-11-120300 (magnesium perchlorate and the like) may be used in addition to alkali catalysts (KOH, CsOH and the like).

Examples of the polyester polyol (A2) include those in (1) to (5) mentioned below.

(1) Ester of polyhydric alcohol and polycarboxylic acid or ester-forming derivative thereof

The polyhydric alcohol is a dihydric alcohol (ethylene glycol, diethylene glycol, 1,2- and 1,3-propylene glycols, 1,3- and 1,4-butanediols, 1,6-hexanediol, neopentyl glycol, and the like), a polyether polyol (preferably a diol), a mixture of these above and a polyhydric alcohol as a trihydric or more alcohol (glycerol, trimethylol propane, and the like), or the like. The polycarboxylic acid or the ester-forming derivative thereof is an acid anhydride, a lower alkyl (the number of carbon atoms of the alkyl group: 1 to 4) ester, or the like, and examples thereof include adipic acid, sebacic acid, maleic anhydride, phthalic anhydride, dimethyl terephthalate, and the like.

(2) Condensed reactant of carboxylic acid anhydride and AO
(3) AO (EO, PO and the like) adduct of (1) and (2) mentioned above
(4) Polylactone polyol

Examples thereof include those obtained by allowing a lactone (ε-caprolactone and the like) to undergo a ring opening polymerization using a polyhydric alcohol as an initiator, and the like.

(5) Polycarbonate polyol

Examples thereof include a reactant of the polyhydric alcohol and an alkylene carbonate, and the like.

Examples of the polyhydric alcohol (A3) include dihydric alcohols with 2 to 20 carbon atoms {linear or branched aliphatic diols (alkylene glycols such as ethylene glycol, propylene glycol, 1,3- and 1,4-butanediols, 1,6-hexanediol and neopentyl glycol; polyalkylene glycols such as diethylene glycol and dipropylene glycol) and alicyclic diols (cycloalkylene glycols such as cyclohexanediol and cyclohexanedimethanol)}, trihydric alcohols with 3 to 20 carbon atoms {aliphatic triols (alkanetriols such as glycerol, trimethylol propane, trimethylol ethane and hexanetriol)}; polyhydric alcohols as tetra- to octahydric or more alcohols with 5 to 20 carbon atoms {aliphatic polyols (alkanepolyols such as pentaerythritol, sorbitol, mannitol, sorbitan, diglycerol and dipentaerythritol, and an intramolecular or intermolecular dehydration product of those above or alkanetriols; and saccharides such as sucrose, glucose, mannose, fructose and methyl glucoside and a derivative thereof)}, and the like. Two or more kinds thereof may be combinedly used.

Examples of polyols other than those mentioned above and a monool (A4) include polydiene polyols such as polybutadiene polyols and a hydrogenated product thereof; an acryl-based polyol, hydroxyl group-containing vinyl polymers described in JP-A-58-57413, JP-A-58-57414 and the like; natural fat-based polyols such as castor oil; modified products of natural fat-based polyols such as castor oil-modified products (a polyhydric alcohol-transesterification product, a hydrogenated product, and the like); terminal radically polymerizable functional group-containing active hydrogen compounds (monools are also included) described in WO 98/44016 A; a modified polyol prepared by allowing a polyether polyol to jump with an alkylene dihalide such as a methylene dihalide, or the like; an OH terminal-prepolymer of a polyether polyol; and the like.

Examples of the polymer polyol (A5) include those prepared by allowing an ethylenically unsaturated monomer (p) to undergo a polymerization in the presence of a radical polymerization initiator in at least one kind of (A0) and (A1) to (A4) and dispersing the resulting polymer (p) stably in the polyol. As the (A5), those obtained by allowing the (p) to undergo a polymerization in (A0) or (A1) are preferred in terms of dispersion stability. Specific examples of the polymerization method include methods described in U.S. Pat. No. 3,383,351, JP 39-25737 B and the like.

In this connection, in the present invention, the (A0) and the (A1) to the (A4) which are used as raw materials of the polymer polyol (A5) are not included in (A0) and (A1) to (A4).

As the radical polymerization initiator, one that generates a free radical to initiate the polymerization can be used, and examples thereof include azo compounds such as 2,2′-azobisisobutyronitrile, 2,2′-azobis(2,4-dimethylvaleronitrile) and 2,2′-azobis(2-methylbutyronitrile); organic peroxides such as dibenzoyl peroxide, dicumyl peroxide, benzoyl peroxide, lauroyl peroxide and persuccinic acid; inorganic peroxides such as a persulfate and a perborate; and the like. In this connection, two or more kinds thereof can be combinedly used.

Examples of the ethylenically unsaturated monomer (p) include an unsaturated nitrile (p1), an aromatic ring-containing monomer (p2), a (meth)acrylic acid ester (p3), another ethylenically unsaturated monomer (p4), a mixture of two or more kinds thereof, and the like.

Examples of the (p1) include acrylonitrile, methacrylonitrile, and the like.

Examples of the (p2) include styrene, α-methylstyrene, hydroxystyrene, chlorostyrene, and the like.

Examples of the (p3) include those composed of C, H and O atoms such as (meth)acrylic acid alkylesters (the number of carbon atoms of the alkyl group is 1 to 24) [methyl (meth)acrylate, butyl (meth)acrylate, nonyl (meth)acrylate, decyl (meth)acrylate, dodecyl (meth)acrylate, eicosyl (meth)acrylate, docosyl (meth)acrylate, and the like], hydroxyalkyl (the number of carbon atoms of 2 to 5) (meth)acrylates [hydroxyethyl (meth)acrylate, and the like], and hydroxy polyoxyalkylene mono(meth)acrylates [the number of carbon atoms of the alkylene group of 2 to 4, the number average molecular weight of the polyoxyalkylene chain of 200 to 1000, and the like].

Examples of the (p4) include an ethylenically unsaturated carboxylic acid and a derivative thereof, specifically, (meth)acrylic acid, (meth)acrylamide, and the like; an aliphatic or alicyclic hydrocarbon monomer, specifically, alkenes (ethylene, propylene, norbornene and the like) and alkadienes (butadiene and the like), and the like; a fluorine-based vinyl monomer, specifically, fluorine-containing (meth)acrylates (perfluorooctylethyl methacrylate, perfluorooctylethyl acrylate, and the like), and the like; a chlorine-based vinyl monomer, specifically, vinylidene chloride and the like; nitrogen-containing vinyl monomers other than those mentioned above, specifically, nitrogen-containing (meth)acrylates (diaminoethyl methacrylate, morpholinoethyl methacrylate, and the like), and the like; and vinyl-modified silicone, and the like.

Of these examples of the (p), from the viewpoint of moldability, the (p1) and the (p2) are preferred, and further preferred are acrylonitrile and/or styrene.

The weight ratio of the (p1), the (p2), the (p3) and the (p4) in the ethylenically unsaturated monomer (p) can vary depending on required physical properties of polyurethane and is not particularly limited, but an example thereof is as follows.

The amount of the (p1) and/or the (p2) is preferably 50 to 100% by weight and further preferably 80 to 100% by weight, based on the total weight of the (p). The weight ratio of the (p1) to the (p2) is not particularly limited, but is preferably 100/0 to 20/80. The amount of the (p3) is preferably 0 to 50% by weight and further preferably 0 to 20% by weight. The amount of the (p4) is preferably 0 to 10% by weight and further preferably 0 to 5% by weight.

From the viewpoint of moldability, the content of the polymer of the (p) in the polymer polyol (A5) is preferably 50% by weight or less and further preferably 3 to 30% by weight, based on the total weight of the (A5).

Examples of the amine (A6) include one that has a number of active hydrogen atoms of 2 to 8 or more, and include ammonia; as aliphatic amines, alkanolamines with 2 to 20 carbon atoms (monoethanolamine, diethanolamine, triethanolamine, isopropanolamine, aminoethylethanolamine, and the like), alkylamines with 1 to 20 carbon atoms (n-butylamine, octylamine, and the like), alkylenediamines with 2 to 6 carbon atoms (ethylenediamine, propylenediamine, hexamethylenediamine, and the like), and polyalkylene polyamines with 4 to 20 carbon atoms (a dialkylene triamine to hexaalkylene heptaamine with 2 to 6 carbon atoms of the alkylene group, diethylene triamine, triethylene tetraamine, and the like).

Moreover, examples thereof include aromatic mono- or polyamines with 6 to 20 carbon atoms (aniline, phenylenediamine, tolylenediamine, xylylenediamine, diethyltoluenediamine, methylenedianiline, diphenyl ether diamine, and the like); alicyclic amines with 4 to 20 carbon atoms (isophoronediamine, cyclohexylenediamine, dicyclohexylmethanediamine, and the like); heterocyclic amines with 4 to 20 carbon atoms (piperazine, aminoethyl piperazine, those described in JP 55-21044 B, and the like), and combined use of two or more kinds thereof, and the like.

Of these, from the viewpoint of moldability, the polyether polyol (A1) and the polymer polyol (A5) are preferred.

From the viewpoints of curing properties and mechanical properties, the total content of the (A1), the (A2), the (A3), the (A4), the (A5) and the (A6) is preferably 2 to 92% by weight, further preferably 3 to 90% by weight, especially preferably 5 to 88% by weight and most preferably 10 to 80% by weight, based on the total weight of the active hydrogen component (A).

From the viewpoint of moldability of polyurethane foam, it is preferred that the organic polyisocyanate (B) in the present invention be composed of one or more kinds of polyisocyanates selected from 2,4- and 2,6-tolylene diisocyanates (hereinafter, abbreviated as TDIs), crude materials thereof and modified products thereof (hereinafter, these isocyanates are abbreviated as TDI-based polyisocyanates) in an amount of 70% by weight or more and another polyisocyanate in an amount of 30% by weight or less, based on the total weight of the (B). The content of the TDI-based polyisocyanate is further preferably 75 to 95% by weight. Examples of the modified product include urethane group-, carbodiimide group-, allophanate group-, urea group-, biuret group-, isocyanurate group- and oxazolidone group-containing modified products, and the like.

As another polyisocyanate, a divalent or more (preferably di- to octavalent) organic polyisocyanate used for polyurethane foam can be used, and examples thereof include an aromatic polyisocyanate other than the TDI-based polyisocyanate, a linear or branched aliphatic polyisocyanate, an alicyclic polyisocyanate, an aromatic-aliphatic polyisocyanate, and a modified product thereof (for example, the above-mentioned modified product).

Examples of the aromatic polyisocyanate include an aromatic diisocyanate with 6 to 16 carbon atoms (excluding carbon atoms in the NCO group; the same holds true for the following polyisocyanate), an aromatic triisocyanate with 6 to 20 carbon atoms, crude materials of these isocyanates, and the like. Specific examples thereof include 1,3- and 1,4-phenylene diisocyanates, 2,4′- and 4,4′-diphenylmethane diisocyanates (hereinafter, abbreviated as MDIs), a polymethylene polyphenylene polyisocyanate (a crude MDI), naphthylene-1,5-diisocyanate, triphenylmethane-4,4′,4″-triisocyanate, and the like.

Examples of the aliphatic polyisocyanate include an aliphatic diisocyanate with 6 to 10 carbon atoms, and the like. Specific examples thereof include 1,6-hexamethylene diisocyanate, 2,2,4-trimethyl hexamethylene diisocyanate, lysine diisocyanate, and the like.

Examples of the linear or branched alicyclic polyisocyanate include a linear or branched alicyclic polyisocyanate with 6 to 16 carbon atoms, and the like. Specific examples thereof include isophorone diisocyanate, 4,4′-dicyclohexylmethane diisocyanate, 1,4-cyclohexane diisocyanate, norbornane diisocyanate, and the like.

Examples of the aromatic-aliphatic polyisocyanate include an aromatic-aliphatic diisocyanate with 8 to 12 carbon atoms, and the like. Specific examples thereof include xylylene diisocyanate, α,α,α′,α′-tetramethylxylylene diisocyanate, and the like.

Specific examples of a modified polyisocyanate include a carbodiimide-modified MDI, and the like.

Of these other isocyanates, from the viewpoint of moldability, an aromatic polyisocyanate is preferred, and further preferred are an MDI, a crude MDI and modified products of these isocyanates.

As the organic polyisocyanate (B), two or more kinds of an isocyanate and a modified product thereof may be combinedly used.

From the viewpoint of moldability, the isocyanate group content (NCO %) in the whole organic polyisocyanate (B) is preferably 40 to 50%.

The foaming agent (C) used in the present invention contains water. It is preferred that the (C) contain only water.

From the viewpoints of the foaming ratio and disintegrability of the foam, the content in the case where only water is used as the foaming agent (C) is preferably 1 to 7% by weight and further preferably 2 to 6.8% by weight, based on the total weight of the active hydrogen component (A).

It is preferred that only water be used as the foaming agent (C), but as necessary, a hydrogen atom-containing halogenated hydrocarbon, a low-boiling point hydrocarbon, liquefied carbon dioxide, and the like may be used together therewith.

Examples of the hydrogen atom-containing halogenated hydrocarbon-based foaming agent include HCFCs (hydrochlorofluorocarbons) (HCFC-123, HCFC-141b, HCFC-22, HCFC-142b, and the like); HFCs (hydrofluorocarbons) (HFC-134a, HFC-152a, HFC-356mff, HFC-236ea, HFC-245ca, HFC-245fa, HFC-365mfc, and the like), and the like.

Among these, preferred are HCFC-141b, HFC-134a, HFC-356mff, HFC-236ea, HFC-245ca, HFC-245fa and HFC-365mfc and a mixture of two or more kinds thereof.

From the viewpoints of the foaming ratio and disintegrability of the foam, the content in the case where the hydrogen atom-containing halogenated hydrocarbon is used is preferably 50% by weight or less and further preferably 5 to 45% by weight, based on the weight of the active hydrogen component (A).

The low-boiling point hydrocarbon is a hydrocarbon with a boiling point of −5 to 70° C., and examples thereof include butane, pentane, cyclopentane and a mixture thereof, and the like.

From the viewpoints of the foaming ratio and disintegrability of the foam, the content in the case where the low-boiling point hydrocarbon is used is preferably 30% by weight or less and further preferably 25% by weight or less, based on the total weight of the active hydrogen component (A).

From the viewpoints of the foaming ratio and disintegrability of the foam, the content in the case where the liquefied carbon dioxide is used is preferably 30% by weight or less and further preferably 25% by weight or less, based on the total weight of the active hydrogen component (A).

As the urethanation catalyst (D) used in the present invention, a catalyst that promotes a urethanation reaction can be used, and examples thereof include tertiary amines {triethylenediamine, bis(N,N-dimethylamino-2-ethyl)ether, N,N,N′,N′-tetramethyl hexamethylenediamine, and the like}, a carboxylate of a tertiary amine, metal carboxylates (potassium acetate, potassium octylate, stannous octoate, and the like) and organometallic compounds (dibutyltin dilaurate, and the like).

From the viewpoint of reactivity of urethane foam, the content of the (D) is preferably 0.1 to 0.8% by weight and further preferably 0.15 to 0.7% by weight, based on the total weight of the active hydrogen component (A).

As the foam stabilizer (E) used in the present invention, one commonly used for the production of polyurethane foam can be used, and examples thereof include a silicone foam stabilizer, and the like.

Examples of the silicone foam stabilizer include polyether-modified dimethylsiloxane-based foam stabilizers [“SZ-1328”, “SZ-1346” and “SF-2962” available from Dow Corning Toray Co., Ltd., “L-3640” and “L-540” available from Momentive Performance Materials Inc., and the like], dimethylsiloxane-based foam stabilizers [“SRX-253” available from Dow Corning Toray Co., Ltd., and the like], and the like.

From the viewpoint of moldability, the amount of the foam stabilizer (E) used is preferably 0.5 to 3% by weight and further preferably 0.8 to 2.5% by weight, based on the total weight of the active hydrogen component (A).

The additive (F) used in the present invention contains at least one kind selected from the group consisting of a urea compound (F1) represented by general formula (1) below, an amino acid (F2) and a polyhydric phenol (F3).

The additive (F) in the present invention is an additive having a function as an aldehyde scavenger.

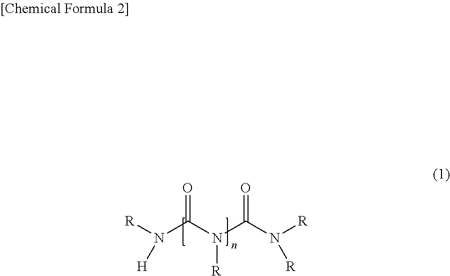

In general formula (1), R represents a hydrogen atom, an alkyl group with 1 to 4 carbon atoms or a hydroxyl group, Rs may be the same as or different from one another, but at least one thereof represents a hydrogen atom. n represents an integer of 0 to 3.

In general formula (1), examples of R include a hydrogen atom, alkyl groups with 1 to 4 carbon atoms (a methyl group, an ethyl group, a propyl group, an isopropyl group, a butyl group, a tert-butyl group, and the like) and a hydroxyl group. Among these, Rs may be the same as or different from one another, but any one thereof represents a hydrogen atom. From the viewpoint of reduction of aldehyde, preferred are a hydrogen atom, a methyl group and a hydroxyl group, and further preferred is a hydrogen atom.

In general formula (1), n represents an integer of 0 to 3, from the viewpoint of reduction effects on aldehyde, 0 or an integer of 1 to 2 is preferred and further preferred is 0.

Examples of the urea compound (F1) represented by general formula (1) include urea, N-methylurea, biuret and carbonyl diurea, and from the viewpoint of reduction effects on aldehyde, urea is preferred.

Examples of the amino acid (F2) include glycine, alanine, valine, leucine, isoleucine, asparagine, glutamine, aspartic acid, glutamic acid, lysine, arginine, phenylalanine, tyrosine, cysteine, methionine, serine, threonine, histidine, tryptophan, proline, and the like.

Of these, from the viewpoint of reduction effects on aldehyde, glycine, aspartic acid and proline are preferred, and further preferred are glycine and aspartic acid.

Examples of the polyhydric phenol (F3) include a polyhydric phenol with a functional group number of 2 to 20 and a molecular weight of 110 to 2000, and specifically, monocyclic polyhydric phenols such as pyrogallol, hydroquinone and phloroglucin; bisphenols such as bisphenol A, bisphenol F and bisphenol sulfone; a condensate (novolak) of phenol and formaldehyde; polyphenols described in U.S. Pat. No. 3,265,641; a polyphenol-containing plant extract and combined use of two or more kinds thereof, and the like are included.

Of these, from the viewpoint of reduction effects on aldehyde, a polyhydric phenol with a functional group number of 2 to 10 and a molecular weight of 110 to 1000 is preferred, and further preferred is a polyhydric phenol with a functional group number of 2 to 5 and a molecular weight of 110 to 500.

With regard to the contents of the (F1) and the (F2) in the case where the (F1) and the (F2) as the additive (F) are contained, from the viewpoints of reduction effects on aldehyde and curing properties, the content of the (F1) is preferably 15 to 98% by weight and the content of the (F2) is preferably 2 to 85% by weight, based on the total weight of the (F).

With regard to the contents of the (F1) and the (F3) in the case where the (F1) and the (F3) are contained, from the viewpoints of reduction effects on aldehyde and curing properties, the content of the (F1) is preferably 15 to 98% by weight and the content of the (F3) is preferably 2 to 85% by weight, based on the total weight of the (F).

With regard to the contents of the (F2) and the (F3) in the case where the (F2) and the (F3) are contained, from the viewpoints of reduction effects on aldehyde and curing properties, the content of the (F2) is preferably 2 to 98% by weight and the content of the (F3) is preferably 2 to 98% by weight, based on the total weight of the (F).

With regard to the contents of the (F1), the (F2) and the (F3) in the case where the (F1), the (F2) and the (F3) are contained, from the viewpoints of reduction effects on aldehyde and curing properties, the content of the (F1) is preferably 8 to 96% by weight, the content of the (F2) is preferably 2 to 46% by weight and the content of the (F3) is preferably 2 to 46% by weight, based on the total weight of the (F).

In this connection, the total content of the (F1), the (F2) and the (F3) in the additive (F) is preferably 60% by weight or more, further preferably 80% by weight or more and especially preferably 100% by weight.

From the viewpoints of reduction effects on aldehyde and moderate curing properties, the total content of the (F) is preferably 0.01 to 3% by weight, further preferably 0.05 to 3% by weight and especially preferably 0.1 to 3% by weight, based on the total weight of the active hydrogen component (A).

As the additive (F), one that contains the urea compound (F1) represented by general formula (1) is preferred, and one that contains the urea compound (F1), the amino acid (F2) and the polyhydric phenol (F3) is further preferred.

In the present invention, known auxiliary components such as a coloring agent, a flame retardant, an aging inhibitor and an anti-oxidizing agent may be used as necessary to perform the reaction in the presence thereof. As the coloring agent, a pigment and a dye are included. As the flame retardant, a phosphoric acid ester, a halogenated phosphoric acid ester, and the like are included. As the aging inhibitor, triazole-based and benzophenone-based aging inhibitors, and the like are included. As the anti-oxidizing agent, hindered phenol-based and hindered amine-based anti-oxidizing agents, and the like are included.

With regard to the amounts of these auxiliary components used, based on the total weight of the active hydrogen component (A), the amount of the coloring agent is preferably 1% by weight or less from the viewpoints of curing properties and mechanical properties, the amount of the flame retardant is preferably 5% by weight or less and further preferably 2% by weight or less from the viewpoints of curing properties and mechanical properties, the amount of the aging inhibitor is preferably 1% by weight or less and further preferably 0.5% by weight or less from the viewpoints of curing properties and mechanical properties, and the amount of the anti-oxidizing agent is preferably 1% by weight or less and further preferably 0.01 to 0.5% by weight from the viewpoints of curing properties and mechanical properties.

In the production method of the present invention, from the viewpoint of moldability, the isocyanate index [(NCO group/active hydrogen atom-containing group)×100] at the time of producing a vehicle seat pad is preferably 70 to 125, further preferably 75 to 120 and especially preferably 80 to 115.

In this connection, one derived from water which is a foaming agent shall be included in the active hydrogen atom-containing group.

An example of the method for producing a vehicle seat pad according to the present invention is as follows. First, prescribed amounts of the active hydrogen component (A), the foaming agent (C), the urethanation catalyst (D), the foam stabilizer (E), the additive (F) and another optional auxiliary component are mixed to prepare a mixture. Then, using a polyurethane foaming machine or stirrer, a flexible polyurethane foam raw liquid obtained by mixing this mixture with the organic polyisocyanate (B) is injected into a mold cavity (for example, at 15 to 70° C.) to which a skin material is previously set, cured for a prescribed period of time, foamed, and then, demolded to obtain a seat pad. From the viewpoint of productivity, preferred is a method of setting a planar skin material to the internal space of a cavity in which a flexible polyurethane foam raw liquid is foam-molded, and foam-molding the flexible polyurethane foam raw liquid into a state where flexible polyurethane foam is integrally bonded to the skin material to obtain a seat pad.

With regard to a mixture including the active hydrogen component (A), the foaming agent (C), the urethanation catalyst (D), the foam stabilizer (E) and the additive (F) and the mixture further including another optional auxiliary component, it is preferred that each of these mixtures not be separated into two phases of a phase containing the (A) and a phase containing water after being allowed to stand for 30 days at 25° C. By relatively increasing the amount of the polyether polyol (A0) in the active hydrogen component (A), the mixture is prevented from being separated into two phases, and the preferred content of the (A0) is as described above.

The material for the skin is not particularly limited, but for example, natural fibers (animal-derived natural fibers, vegetable-derived natural fibers, and the like), synthetic fibers (polypropylene fibers, polyester fibers, polyamide fibers, acrylic fibers, and the like), and mixed spun fibers thereof can be exemplified.

### EXAMPLES

Hereinafter, the present invention will be further described by reference to examples, but the present invention should not be limited by these examples.

In examples described below, methods for measuring the hydroxyl value of the polyol component and the rate of terminals converted into primary hydroxyl groups are as follows.

### <Hydroxyl Value>

The hydroxyl value (mgKOH/g) was measured by a method prescribed in JIS K1557-1.

<Rate of Terminals Converted into Primary Hydroxyl Groups>

In the present invention, the rate of terminals converted into primary hydroxyl groups is calculated by the ¹H-NMR method after a sample is previously subjected to a pretreatment for esterification. The details of the ¹H-NMR method will be specifically described below.

Sample Preparation Procedure

About a 30-mg portion of a sample for measurement is weighed into a sample tube for ¹H-NMR with a diameter of 5 mm and added with 0.5 ml of a deuterated solvent to be dissolved. Afterward, 0.1 ml of trifluoroacetic anhydride is added and the contents are allowed to stand for about 5 minutes at 25° C., and the polyol is made into a trifluoroacetic acid ester to obtain a sample for analysis. In this context, the deuterated solvent refers to deuterated chloroform, deuterated toluene, deuterated dimethyl sulfoxide, deuterated dimethylformamide, or the like, and a solvent in which the sample can be dissolved is appropriately selected.

¹H-NMR Measurement

The ¹H-NMR measurement is performed under normal conditions.

Method for Calculating Rate of Terminals Converted into Primary Hydroxyl Groups

Since a signal derived from a methylene group to which a terminal primary hydroxyl group is bonded is observed at about 4.3 ppm and a signal derived from a methine group to which a terminal secondary hydroxyl group is bonded is observed at about 5.2 ppm, the rate of terminals converted into primary hydroxyl groups is calculated according to the following equation [1]:

Rate of terminals converted into primary hydroxyl groups (%)=[r/(r+2s)]×100 [1]
wherein,
r is an integrated value of a signal derived from a methylene group, to which a terminal primary hydroxyl group is bonded, at about 4.3 ppm, and
s is an integrated value of a signal derived from a methine group, to which a terminal secondary hydroxyl group is bonded, at about 5.2 ppm.

Examples 1 to 22 and Comparative Examples 1 to 3

A premix including an active hydrogen component (A), a foaming agent (C), a urethanation catalyst (D), a foam stabilizer (E) and an additive (F) shown in Tables 1, 2 and an organic polyisocyanate (B) were placed into respective raw material tanks of a high-pressure urethane foaming machine (available from Polyurethane Engineering Co., LTD.), and the liquid temperatures were adjusted to 25° C. Afterward, with the high-pressure urethane foaming machine, the premix and the organic polyisocyanate (B) in an amount that the isocyanate index becomes 100 were discharged under a high pressure of 15 MPa and mixed with each other, and the mixture was injected into an aluminum mold with a size of 400 mm (length)×400 mm (width)×100 mm (height), the temperature of which was adjusted to 65° C., or an aluminum mold for automobile seat cushion pad molding (practically used mold) to which a skin material was set to be molded for a curing time of 6 minutes.

Respective measurement results such as physical property values of foam are shown in Tables 1, 2 (The measurement results obtained by means of the rectangular parallelopiped aluminum mold are shown because there is no great difference in the foam physical property between the rectangular parallelopiped aluminum mold and the practically used mold). In this connection, a core density is a density obtained by measuring a portion with a size of 100 mm×100 mm×50 mm cut out from the center part of the foam.

TABLE 1

| | | | Example | | | | | | |
|---|---|---|---|---|---|---|---|---|---|
| | | | 1 | 2 | 3 | 4 | 5 | 6 | 7 |
| Part(s) | Active | (A0-1) | 25 | 25 | 25 | 25 | 25 | 25 | 25 |
| by | hydrogen | (A0-2) | 30 | 30 | 30 | 30 | 30 | 30 | 30 |
| weight | component | (A5-1) | 45 | 45 | 45 | 45 | 45 | 45 | 45 |
| | (A) | (A1-1) | 1.5 | 1.5 | 1.5 | 1.5 | 1.5 | 1.5 | 1.5 |
| | | (A1-2) | 0.5 | 0.5 | 0.5 | 0.5 | 0.5 | 0.5 | 0.5 |
| | | (A6-1) | 2 | 2 | 2 | 2 | 2 | 2 | 2 |
| | Additive | (F1-1) | 0.01 | 0.5 | 3.0 | | | | 0.5 |
| | (F) | (F1-2) | | | | 0.5 | | | |
| | | (F2-1) | | | | | 0.5 | | 0.01 |
| | | (F2-2) | | | | | | | |
| | | (F3-1) | | | | | | 0.5 | |
| | | (F3-2) | | | | | | | |
| | | (F′-1) | | | | | | | |
| | Foaming agent | (C-1) | 2.2 | 2.2 | 2.2 | 2.2 | 2.2 | 2.2 | 2.2 |
| | (C) | | | | | | | | |
| | Urethanation | (D-1) | 0.4 | 0.4 | 0.2 | 0.4 | 0.4 | 0.4 | 0.4 |
| | catalyst (D) | (D-2) | 0.06 | 0.06 | 0.04 | 0.06 | 0.06 | 0.06 | 0.06 |
| | Foam | (E-1) | 1.0 | 1.0 | 1.0 | 1.0 | 1.0 | 1.0 | 1.0 |
| | stabilizer (E) | | | | | | | | |

| | | | | | | | | |
|---|---|---|---|---|---|---|---|---|
| Organic | (B-1) | 100 | 100 | 100 | 100 | 100 | 100 | 100 |
| polyisocyanate (B) | (Isocyanate index) | | | | | | | |
| Foam physical | Core density | 60.1 | 60.2 | 60.2 | 60.3 | 60.2 | 60.1 | 60.4 |
| properties | Hardness (25% ILD) | 273 | 274 | 273 | 274 | 271 | 275 | 275 |
| | Resilience | 68 | 68 | 68 | 68 | 68 | 68 | 68 |
| | Gel time (s) | 70 | 70 | 70 | 70 | 70 | 70 | 70 |
| Amount of aldehyde | FA | 0.4 | 0.3 | 0.2 | 0.3 | 0.3 | 0.4 | 0.3 |
| diffused (μg/sample) | AA | 0.6 | 0.5 | 0.4 | 0.5 | 0.5 | 0.5 | 0.5 |

| | | | Example | | | | | |
|---|---|---|---|---|---|---|---|---|
| | | | 8 | 9 | 10 | 11 | 12 | 13 |
| Part(s) | Active | (A0-1) | 25 | 25 | 25 | 25 | 25 | 25 |
| by | hydrogen | (A0-2) | 30 | 30 | 30 | 30 | 30 | 30 |
| weight | component | (A5-1) | 45 | 45 | 45 | 45 | 45 | 45 |
| | (A) | (A1-1) | 1.5 | 1.5 | 1.5 | 1.5 | 1.5 | 1.5 |
| | | (A1-2) | 0.5 | 0.5 | 0.5 | 0.5 | 0.5 | 0.5 |
| | | (A6-1) | 2 | 2 | 2 | 2 | 2 | 2 |
| | Additive | (F1-1) | 0.5 | 0.5 | 0.5 | 0.5 | 0.5 | 0.5 |
| | (F) | (F1-2) | | | | | | |
| | | (F2-1) | 0.5 | 2.5 | | | | |
| | | (F2-2) | | | 0.5 | | | |
| | | (F3-1) | | | | 0.01 | 0.5 | 2.5 |
| | | (F3-2) | | | | | | |
| | | (F′-1) | | | | | | |
| | Foaming agent | (C-1) | 2.2 | 2.2 | 2.2 | 2.2 | 2.2 | 2.2 |
| | (C) | | | | | | | |
| | Urethanation | (D-1) | 0.4 | 0.3 | 0.4 | 0.4 | 0.4 | 0.3 |
| | catalyst (D) | (D-2) | 0.06 | 0.05 | 0.06 | 0.06 | 0.06 | 0.06 |
| | Foam | (E-1) | 1.0 | 1.0 | 1.0 | 1.0 | 1.0 | 1.0 |
| | stabilizer (E) | | | | | | | |

| | | | | | | | |
|---|---|---|---|---|---|---|---|
| Organic | (B-1) | 100 | 100 | 100 | 100 | 100 | 100 |
| polyisocyanate (B) | (Isocyanate index) | | | | | | |
| Foam physical | Core density | 60.1 | 60.2 | 60.3 | 60.5 | 60.1 | 60.2 |
| properties | Hardness (25% ILD) | 271 | 272 | 275 | 278 | 271 | 272 |
| | Resilience | 68 | 68 | 68 | 68 | 68 | 68 |
| | Gel time (s) | 70 | 70 | 70 | 70 | 70 | 70 |
| Amount of aldehyde | FA | 0.2 | 0.2 | 0.3 | 0.3 | 0.2 | 0.2 |
| diffused (μg/sample) | AA | 0.4 | 0.3 | 0.5 | 0.6 | 0.4 | 0.3 |

TABLE 2

| | | | Example | | | | | |
|---|---|---|---|---|---|---|---|---|
| | | | 14 | 15 | 16 | 17 | 18 | 19 |
| Part(s) | Active hydrogen | (A0-1) | 25 | 25 | 25 | 25 | 25 | 25 |
| by | component | (A0-2) | 30 | 30 | 30 | 30 | 30 | 40 |
| weight | (A) | (A5-1) | 45 | 45 | 45 | 45 | 45 | 35 |
| | | (A1-1) | 1.5 | 1.5 | 1.5 | 1.5 | 1.5 | 1.5 |
| | | (A1-2) | 0.5 | 0.5 | 0.5 | 0.5 | 0.5 | 0.5 |
| | | (A6-1) | 2 | 2 | 2 | 2 | 2 | 2 |
| | Additive | (F1-1) | 0.5 | 0.1 | 0.5 | 1.0 | 2.5 | 0.5 |
| | (F) | (F1-2) | | | | | | |
| | | (F2-1) | | 0.1 | 0.1 | 0.1 | 0.2 | |
| | | (F2-2) | | 0.1 | 0.1 | 0.1 | 0.2 | |
| | | (F3-1) | | | | | | |
| | | (F3-2) | 0.5 | 0.1 | 0.1 | 0.1 | 0.1 | |
| | | (F′-1) | | | | | | |
| | Foaming | (C-1) | 2.2 | 2.2 | 2.2 | 2.2 | 2.2 | 5.7 |
| | agent(C) | | | | | | | |
| | Urethanation | (D-1) | 0.4 | 0.4 | 0.4 | 0.3 | 0.2 | 0.4 |
| | catalyst (D) | (D-2) | 0.06 | 0.06 | 0.06 | 0.05 | 0.04 | 0.06 |
| | Foam | (E-1) | 1.0 | 1.0 | 1.0 | 1.0 | 1.0 | 1.5 |
| | stabilizer (E) | | | | | | | |
| Organic | | (B-1) | 100 | 100 | 100 | 100 | 100 | 100 |
| polyisocyanate (B) | | (Isocyanate index) | | | | | | |
| Foam physical | | Core density | 60.4 | 60.2 | 60.4 | 60.1 | 60.5 | 25.1 |
| properties | | Hardness (25% ILD) | 276 | 275 | 277 | 273 | 278 | 153 |
| | | Resilience | 68 | 68 | 68 | 68 | 68 | 63 |
| | | Gel time (s) | 70 | 70 | 70 | 70 | 70 | 70 |
| Amount of aldehyde | | FA | 0.2 | 0.3 | 0.1 | 0.1 | 0.1 | 0.3 |
| diffused (μg/sample) | | AA | 0.4 | 0.5 | 0.3 | 0.2 | 0.2 | 0.5 |
| | | | Example | | | Comparative Example | | |
| | | | 20 | 22 | 22 | 1 | 2 | 3 |
| Part(s) | Active hydrogen | (A0-1) | 30 | 5 | 40 | 25 | 25 | 25 |
| by | component | (A0-2) | 10 | 45 | 20 | 30 | 30 | 30 |
| weight | (A) | (A5-1) | 60 | 50 | 40 | 45 | 45 | 45 |
| | | (A1-1) | 1.5 | 3.0 | 1.5 | 1.5 | 1.5 | 1.5 |
| | | (A1-2) | 0.5 | 0.5 | 0.5 | 0.5 | 0.5 | 0.5 |
| | | (A6-1) | 2 | 2 | 2 | 2 | 2 | 2 |
| | Additive | (F1-1) | 0.5 | 0.5 | 0.5 | | | |
| | (F) | (F1-2) | | | | | | |
| | | (F2-1) | | | | | | |
| | | (F2-2) | | | | | | |
| | | (F3-1) | | | | | | |
| | | (F3-2) | | | | | | |
| | | (F′-1) | | | | | 0.1 | 3.0 |
| | Foaming | (C-1) | 1.3 | 2.4 | 3.0 | 2.2 | 2.2 | 2.2 |
| | agent(C) | | | | | | | |
| | Urethanation | (D-1) | 0.4 | 0.4 | 0.4 | 0.4 | 0.4 | 0.4 |
| | catalyst (D) | (D-2) | 0.06 | 0.06 | 0.06 | 0.06 | 0.06 | 0.06 |
| | Foam | (E-1) | 0.5 | 1.5 | 1.0 | 1.0 | 1.0 | 1.0 |
| | stabilizer (E) | | | | | | | |

| | | | | | | | |
|---|---|---|---|---|---|---|---|
| Organic | (B-1) | 100 | 100 | 100 | 100 | 100 | 100 |
| polyisocyanate (B) | (Isocyanate index) | | | | | | |
| Foam physical | Core density | 99.7 | 57.1 | 45.2 | 60.1 | 60.2 | 60.1 |
| properties | Hardness (25% ILD) | 395 | 303 | 251 | 273 | 274 | 275 |
| | Resilience | 70 | 51 | 75 | 68 | 68 | 68 |
| | Gel time (s) | 70 | 70 | 70 | 70 | 70 | 80 |
| Amount of aldehyde | FA | 0.3 | 0.3 | 0.3 | 2.0 | 1.5 | 0.6 |
| diffused (μg/sample) | AA | 0.5 | 0.5 | 0.5 | 2.0 | 1.8 | 0.9 |

The abbreviations of respective components in Tables 1, 2 are as follows.

### [Polyether Polyol (A0)]

(A0-1): a polyol with a hydroxyl value of 30.0 (mgKOH/g), a content of the terminal ethylene oxide of 8% by weight and a rate of terminals converted into primary hydroxyl groups of 85% obtained by adding 118.4 moles of PO to 1 mole of pentaerythritol while using cesium hydroxide as a catalyst, removing the cesium hydroxide by a routine procedure, then, adding 16.0 moles of PO thereto while using tris(pentafluorophenyl)borane as a catalyst in the same manner as in Example 1 of JP-A-2000-344881, furthermore, adding 13.6 moles of EO thereto by block addition while using potassium hydroxide as a catalyst and removing the catalyst components by a routine procedure

(A0-2): a polyol with a hydroxyl value of 34.0 (mgKOH/g), a content of the terminal ethylene oxide of 14% by weight and a rate of terminals converted into primary hydroxyl groups of 75% obtained by adding 71.8 moles of PO to 1 mole of glycerol while using potassium hydroxide as a catalyst, then furthermore, adding 15.8 moles of EO thereto by block addition while using potassium hydroxide as a catalyst and removing the potassium hydroxide by a routine procedure

(A0-3): a polyol with a hydroxyl value of 24.0 (mgKOH/g), a content of the terminal ethylene oxide of 12% by weight and a rate of terminals converted into primary hydroxyl groups of 75% obtained by adding 141.8 moles of PO to 1 mole of pentaerythritol while using potassium hydroxide as a catalyst, then furthermore, adding 25.5 moles of EO thereto by block addition while using potassium hydroxide as a catalyst and removing the potassium hydroxide by a routine procedure

[Active Hydrogen Component (A) Other than (A0)]
(A5-1): a polymer polyol prepared by allowing acrylonitrile and styrene (weight ratio: 70/30) to undergo a copolymerization in polyols (A0-2) and (A0-3) (weight ratio: 96/4) (the polymer content of 33.5% by weight), the hydroxyl value=22.0 (mgKOH/g)
(A1-1): an ethylene oxide adduct of sorbitol, the hydroxyl value=1247 (mgKOH/g), the content of the terminal ethylene oxide of 33% by weight
(A1-2): a propylene oxide-ethylene oxide adduct of glycerol, the hydroxyl value=24.0 (mgKOH/g), the content of the terminal ethylene oxide of 70% by weight
(A6-1): triethanolamine, the hydroxyl value=1130 (mgKOH/g)

### [Additive (F)]

(F1-1): Urea
(F1-2): N-methylurea
(F2-1): Glycine
(F2-2): Aspartic acid
(F3-1): Hydroquinone
(F3-2): Bistheaflavin A
(F′-1): Carbodihydrazide

### [Foaming Agent (C)]

(C-1): Water

### [Urethanation Catalyst (D)]

(D-1): a solution of 33% by weight triethylenediamine in dipropylene glycol [“DABCO-33LV” available from Air Products Japan, Inc.]
(D-2): a solution of 70% by weight bis-N,N-dimethylaminoethyl ether in dipropylene glycol [“TOYOCAT ET” available from Tosoh Corporation]

### [Foam Stabilizer (E)]

(E-1): a polyether-modified dimethylsiloxane-based foam stabilizer [“SZ-1328” available from Dow Corning Toray Co., Ltd.]

### [Organic Polyisocyanate (B)]

(B-1): TDI/MDI (weight ratio)=80/20, NCO %=44.6% [“CE-729” available from Nippon Polyurethane Industry Co., Ltd.]

### <Physical Properties Test>

<1>: Core density (kg/m³)
<2>: Hardness (25% ILD) (N/314 cm²)
<3>: Resilience (%)

The measurements for <1> to <3> were performed in accordance with JIS K6400.

### <Gel Time>

The free-foaming was performed, each of pachinko balls was dropped from above the foam at constant time intervals, and the time at which the ball that did not reach the bottom face of the foam for the first time was dropped was defined as the gel time.

### <Measurement for Amount of Aldehyde Diffused>

Respective flexible polyurethane foam molded bodies obtained were measured for the amounts of formaldehyde (hereinafter, abbreviated as FA) and acetaldehyde (hereinafter, abbreviated as AA) diffused. With regard to the measurement, a test piece with a rectangular parallelopiped shape of 100 mm in longitudinal length×80 mm in transversal length×100 mm in thickness was cut out from each of the above-mentioned respective molded bodies to obtain a sample, this sample was placed in a sampling bag and the inside of the bag was replaced with high purity nitrogen gas. The bag was heated for 2 hours in an oven at 65° C., and 3 L of gas in the bag was scavenged in a DNPH cartridge (GL Pak mini AERO: available from GL Sciences Inc.). The gas scavenged by the DNPH cartridge was eluted with 5 mL of acetonitrile. This solution was quantitatively analyzed for FA and AA by means of high performance liquid chromatography (Prominence Series: available from SHIMADZU CORPORATION).

### (Measurement Conditions)

Column used: SUMIPAX ODS C-05-4615 (available from Sumika Chemical Analysis Service, Ltd.)

Detector: UV detector (measuring wavelength: 360 nm)

Mobile phase: acetonitrile:water=45:55% by volume

Flow velocity: 0.8 ml

Column temperature: 40° C.

Volume of injection: 20 l

As apparent from the results in Tables 1, 2, in examples of the present invention, the amount of aldehyde diffused is extremely reduced as compared with comparative examples, and the examples of the present invention are excellent in curing properties as compared with Comparative Example 3. Moreover, even in the case where the amount of the urethanation catalyst used is more reduced, excellent curing properties are exhibited.

### INDUSTRIAL APPLICABILITY

The vehicle seat pad obtained by the production method of the present invention is useful as a seat pad capable of reducing the diffusion of aldehydes.

1. A method for producing a vehicle seat pad, comprising Step (I) of obtaining flexible polyurethane foam by allowing an active hydrogen component (A) and an organic polyisocyanate (B) to undergo a reaction in the presence of a foaming agent (C), a urethanation catalyst (D), a foam stabilizer (E) and an additive (F), wherein the (C) contains water, the (F) contains at least one kind selected from the group consisting of a urea compound (F1) represented by general formula (1) below, an amino acid (F2) and a polyhydric phenol (F3), the flexible polyurethane foam has a core density of 25 to 90 kg/m³, a resilience of 50 to 75% and a hardness (25%-ILD) of 150 to 400 N/cm². 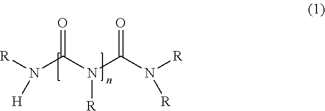
[In general formula (1), R represents a hydrogen atom, an alkyl group with 1 to 4 carbon atoms or a hydroxyl group, Rs may be the same as or different from one another, but at least one of Rs represents a hydrogen atom. n represents an integer of 0 to 3.]

2. The method for producing a vehicle seat pad according to claim 1, wherein an amount of the additive (F) used is 0.01 to 3% by weight, based on a weight of the active hydrogen component (A).

3. The method for producing a vehicle seat pad according to claim 1, the method comprising injecting, into a mold cavity to which a planar skin material is previously set, a flexible polyurethane foam raw liquid obtained by mixing a mixture including the active hydrogen component (A), the foaming agent (C), the urethanation catalyst (D), the foam stabilizer (E), the additive (F) and another optional auxiliary component with the organic polyisocyanate (B); curing and foaming the raw liquid; and foam-molding the raw liquid into a state where flexible polyurethane foam is integrally bonded to the skin material.
